(19) United States
(12) Patent Application Publication
(10) Pub. No.: US 2006/0260735 A1
(43) Pub. Date: Nov. 23, 2006

(54) Method of and apparatus and plant for manufacturing a tyre for a vehicle wheel

(76) Inventor: Gianni Mancini, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/548,327

(22) PCT Filed: Mar. 10, 2003
(86) PCT No.: PCT/IT03/00146

§ 371 Date: Jun. 15, 2006

(51) Int. Cl. B29D 30/06

(52) U.S. Cl. 156/123; 156/133; 156/416

(57) ABSTRACT

A method of manufacturing a tyre for a vehicle wheel includes inflating a bladder of a building support so that a shape of an outer surface of the bladder correlates with a shape of an inner surface of the tyre, applying elementary components onto the building support, introducing the tyre and building support into a vulcanization mould, and curing the tyre. The bladder includes circumferential edges coaxially spaced apart from each other. During curing, the bladder is over-inflated so that the circumferential edges are radially farther from a geometric axis of the bladder than when the bladder is not over-inflated. An apparatus for building a tyre for a vehicle wheel includes the building support and inflating devices associated with the bladder. The building support includes axially opposite anchoring flanges that engage the circumferential edges. Radially sliding members associated with the anchoring flanges allow a radial movement of the circumferential edges.

The present invention relates to a method and an apparatus for manufacturing tyres for vehicle wheels.

In tyre vulcanisation use of a mould comprising a rigid toroidal support the shape of which matches that of the inner conformation of the tyre is known for example from document U.S. Pat. No. 4,895,692. The toroidal support at the inside of the mould defines a predetermined volume within which the tyre must be moulded. Use of this type of mould leads to execution of a vulcanisation of the so-called “imposed-volume” type.

There are also moulding methods of the so-called “imposed-pressure” type in which pressing of the tyre against the inner walls of the mould is provided to be carried out by an expandable membrane inflated with steam under pressure within the tyre itself.

In patent applications WO 01/32409 and EP 876533 in the name of the same Applicant building of a tyre is provided through assembling of the individual components of same in a predetermined sequence on a rigid toroidal support the outer conformation of which is correlated with the configuration of the inner surface of the tyre to be obtained, although said support has slightly smaller sizes than those of the tyre. When assembling is over, the rigid toroidal support and the green tyre formed thereon are introduced into a mould to submit the tyre to a vulcanisation step during which a vulcanisation fluid under pressure is introduced between the outer surface of the toroidal support and inner surface of the tyre to carry out pressing of the tyre against the inner walls of the mould, while imposing some expansion to the tyre itself.

Document U.S. Pat. No. 5,853,526 aims at making a tyre on a support of a conformation as much as possible close to that of the finished tyre as described in document U.S. Pat. No. 4,895,692, and carrying out vulcanisation with a process of the imposed-pressure type, without however involving the necessity to transfer the green tyre from one toroidal support to another. For the purpose a process is proposed that involves formation of the green tyre through assembling of the tyre components using as the reference support, an inflatable bladder inflated to a predetermined pressure. For carrying out vulcanisation, the green tyre and inflatable bladder are closed in a mould, and the pressure in the bladder is brought to a moulding value sufficient to ensure moulding of the tyre. At the end of vulcanisation, the bladder is deflated to enable removal of the tyre.

The Applicant has however perceived that an inflatable bladder of the type required in a process as described in U.S. Pat. No. 5,853,526 must necessarily have a structural rigidity sufficient to ensure correct positioning of the tyre components during the assembling step. This structural rigidity can turn out to be of an excessive amount for a correct execution of the step of moulding and curing the tyre, in particular when a certain radial-expansion degree is wished to be imposed to the tyre in order to cause pressing of same against the inner walls of the mould. In accordance with the present invention, it has been found that for the purpose of ensuring a correct tyre moulding when an important radial expansion of same within the vulcanisation mould is required, it is convenient for the inner circumferential edges of the inflatable bladder to be such arranged as to enable a desired degree of movement of same in a radial and circumferential direction, in order to help the radial expansion of the inflatable bladder and of the tyre built thereon.

In more detail, it is an aim of the present invention to provide a method of manufacturing tyres for vehicle wheels contemplating use of a building drum having an inflatable bladder with coaxially spaced apart circumferential edges and comprising the steps of: setting the inflatable bladder in an inflated condition so that the shape of an outer surface thereof is in correlation with the shape of an inner surface of a green tyre to be built; applying a plurality of elementary components onto the building support so as to build said green tyre; introducing the green tyre and building support into a vulcanisation mould; curing the green tyre, wherein during vulcanisation a step of over-inflating the inflatable bladder is carried out during which the circumferential edges of the inflatable bladder are submitted to a radially outward movement.

It is a further aim of the invention to provide an apparatus for building tyres for vehicle wheels starting from a plurality of elementary components, comprising: a building support including an inflatable bladder of substantially toroidal shape having circumferential edges coaxially spaced apart from each other; inflating devices associated with the inflatable bladder to bring the bladder to an inflated conditions so that the shape of an outer surface thereof is in correlation with the shape of an inner surface of a green tyre to be built; said building support comprising axially opposite anchoring flanges engaging the circumferential edges of the inflatable bladder, wherein the radially sliding members associated with said anchoring flanges allow a radial movement of the circumferential edges of the inflatable bladder.

The invention further proposes a plant for manufacturing tyres for vehicle wheels comprising: a building apparatus having a building support comprising an inflatable bladder of substantially toroidal shape with circumferential edges coaxially spaced apart from each other; inflating devices associated with the inflatable bladder to bring the bladder to an inflated condition so that the shape of an outer surface thereof is in correlation with the shape of an inner surface of a green tyre to be built; devices for applying a plurality of elementary components of said green tyre onto the building support; at least one mould for vulcanisation of the green tyre; devices for transferring of the building support into the vulcanisation mould; wherein the circumferential edges of the inflatable bladder are radially movable in order to promote an additional radial expansion of the inflatable bladder imposed by said inflating devices starting from the inflated condition.

Further features and advantages will become more apparent from the detailed description of a preferred but not exclusive embodiment of a method of manufacturing tyres for vehicle wheels, and a plant provided with a building apparatus adapted to put said method into practice. This description will be set out hereinafter with reference to the accompanying drawings, given by way of non-limiting example, in which:

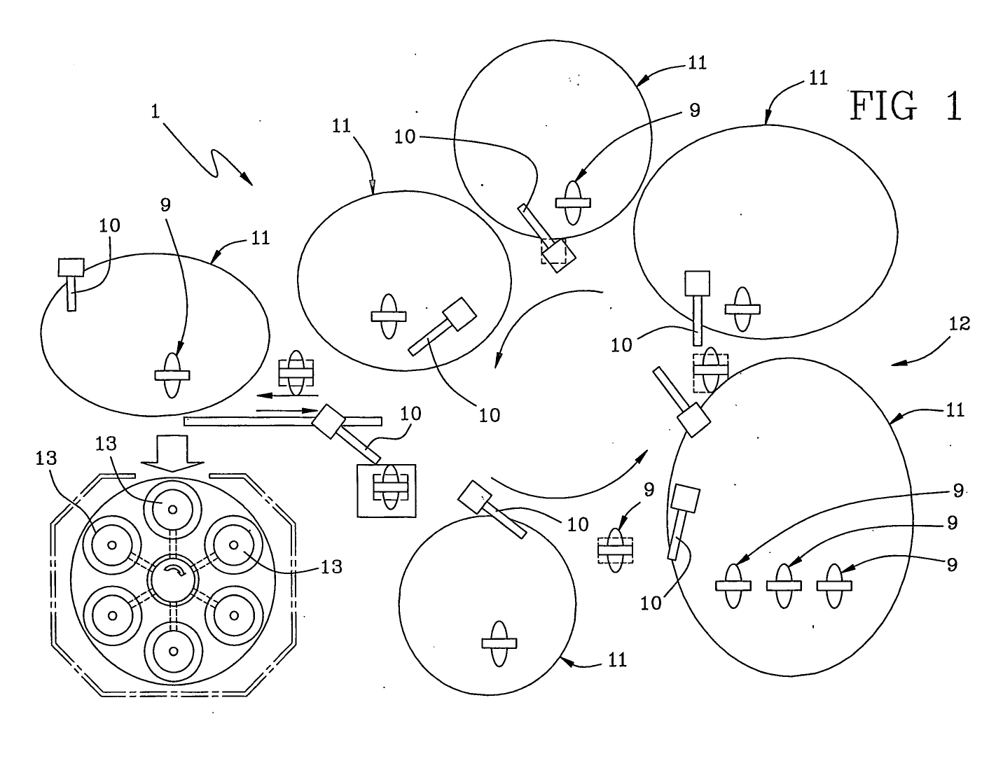

FIG. 1 is a diagrammatic plan view of a plant for manufacturing tyres comprising a building apparatus in accordance with the present invention;

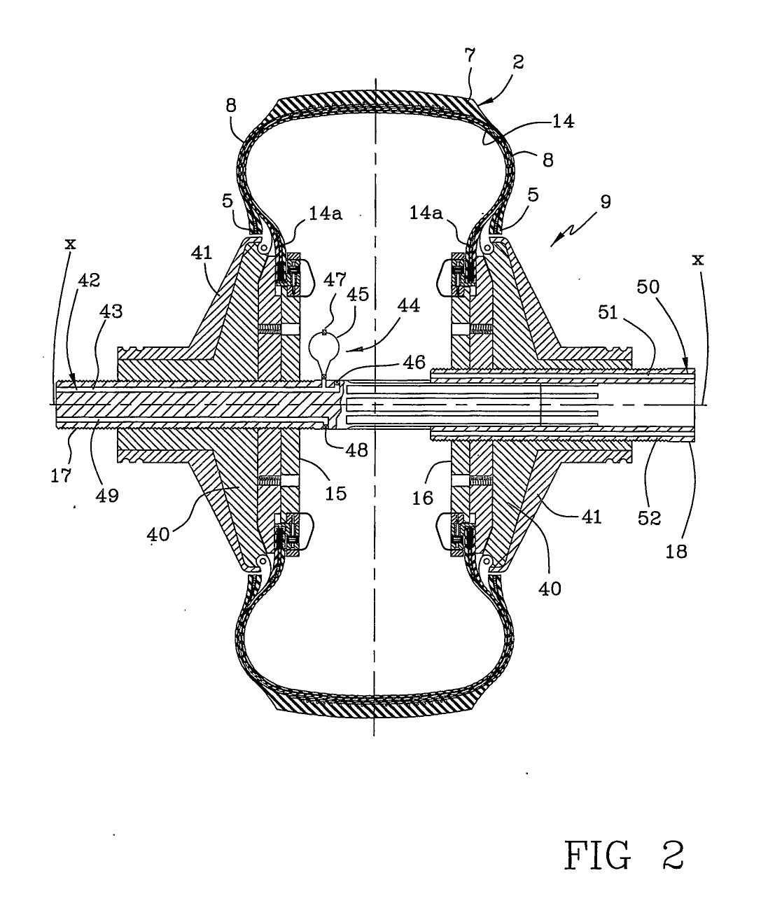

FIG. 2 diagrammatically shows, in diametrical cross-section, a building support being part of the apparatus in question, with an inflatable bladder thereof in an inflated condition;

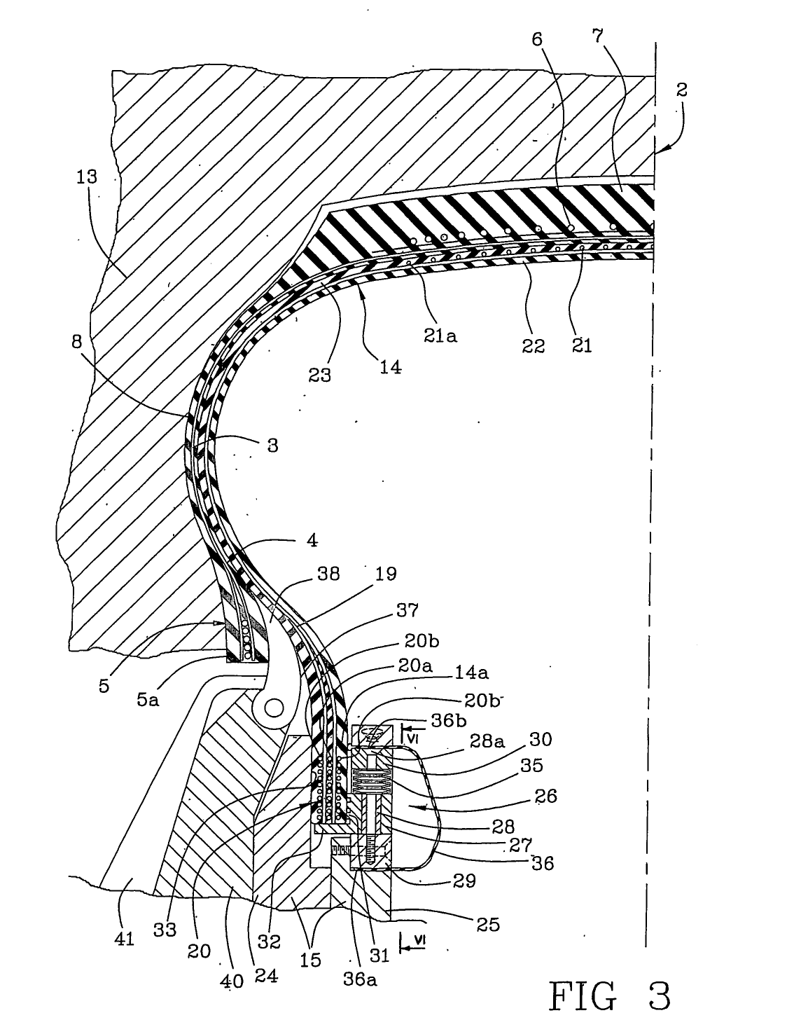

FIG. 3 shows a detail to an enlarged scale of the building support in FIG. 2 with the inflatable bladder in an inflated condition within a vulcanisation mould;

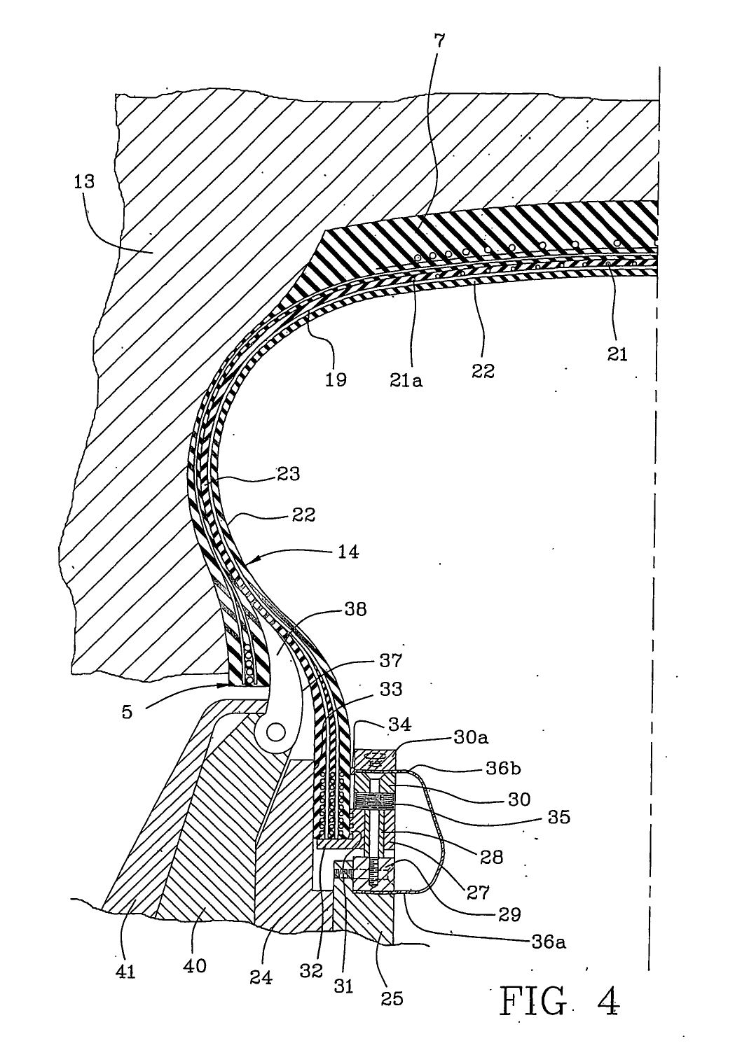

FIG. 4 shows a detail of FIG. 3 with the inflatable bladder in an over-inflated condition;

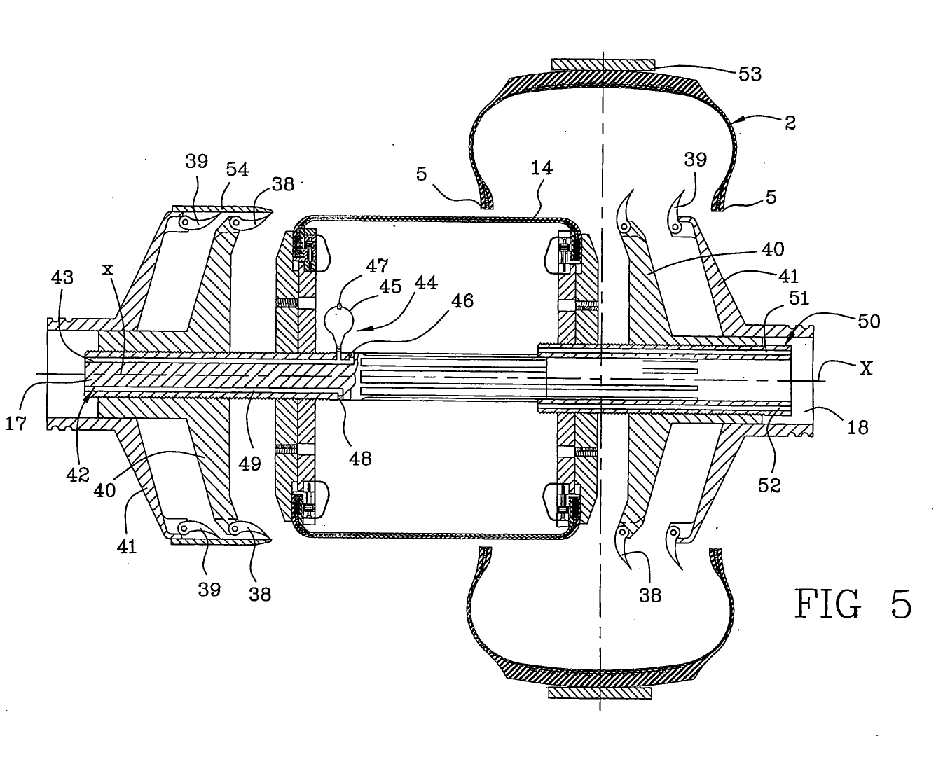

FIG. 5 shows the building support during removal of the finished tyre;

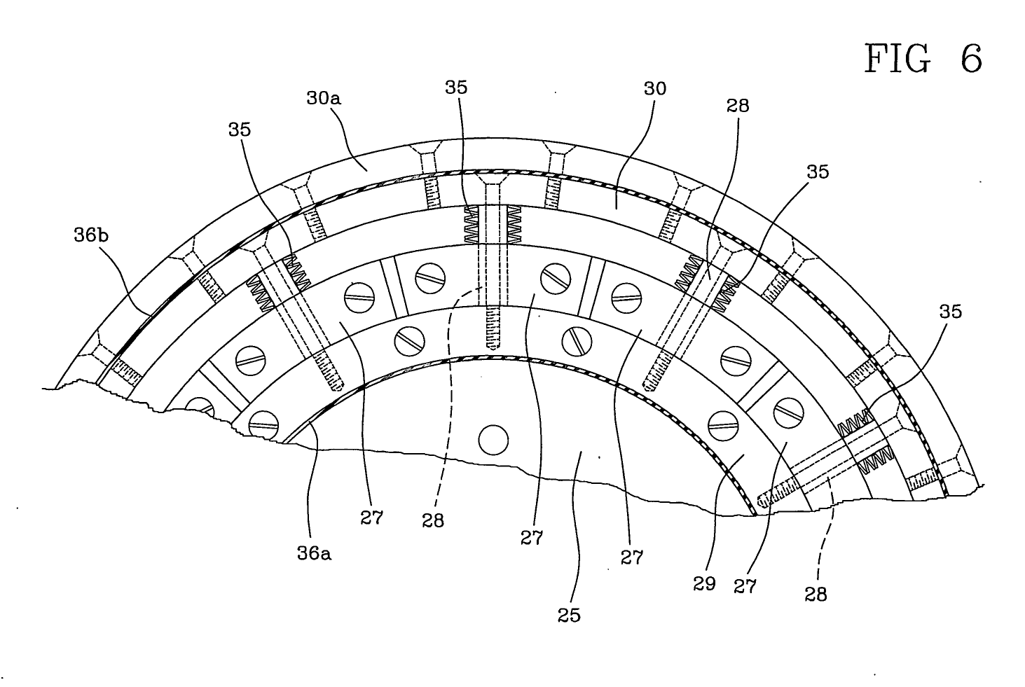

FIG. 6 partly shows one of the anchoring flanges of the building drum, sectioned along line VI-VI in FIG. 3.

With reference to the drawings, a plant for manufacturing tyres for vehicle wheels provided with a building apparatus in accordance with the present invention has been generally identified by reference numeral.

Plant 1 is designed to make tyres 2 essentially comprising at least one carcass ply 2 internally coated with one layer of air-tight elastomer material, a so-called liner 4, two annular anchoring structures 5a in engagement with the circumferential edges of the carcass ply close to the regions usually identified as “beads” 5, a belt structure 6 circumferentially applied around the carcass ply 3, a tread band 7 circumferentially superposed on'the belt structure 6, and two sidewalls 8 applied to the carcass ply 3 at laterally opposite positions and each extending from the corresponding bead 5 to the corresponding side edge of the tread band 7.

Building of tyres 2 is carried out with the aid of an apparatus comprising one or more building supports 9 each of which, through one or more robotized arms 10 or other transfer devices, is sequentially brought to interact with one or more building stations 11 distributed along a building line 12 to cause assembling of components 3, 4, 5, 6, 7, 8 of the respective tyre 2 in a predetermined sequence. In a preferential embodiment, each component 3, 4, 5, 6, 7, 8 of the tyre is directly formed by directly applying one or more elementary components, such as strips or bands of elastomer material, metallic or rubberised textile cords, narrow bands of rubberised cords or others, onto the building support 9, as described in document U.S. Pat. No. 6,318,432 in the name of the same Applicant, for example.

When assembling has been completed the building support 9 and green tyre 2 built thereon, still with the aid of a robotized arm 10 or other suitable transfer device, are transferred to a mould 13 to cause vulcanisation of tyre 2.

The building support 9 essentially comprises an inflatable bladder 14 having circumferential edges 14a axially spaced apart from each other and in engagement with a first and a second anchoring flanges 15, 16, respectively. The first and second anchoring flanges 15, 16 are in engagement with a first and a second shaft 17, 18 respectively, that are telescopically joined together. For the purpose, the first shaft 17 is for example provided to be coaxially insertable into the second shaft 18 which is internally hollow. A locking member not shown, comprising a mechanical hooking for example, to be operated mechanically, electromagnetically, pneumatically or in other manner, ensures a steady axial locking between the first and second shafts 17, 18 while keeping the possibility of disengaging them from one another, for the purposes better clarified in the following.

It may be advantageously provided that at least one of the anchoring flanges 15, 16 should be secured to the respective shaft 17, 18 by screwing, so that it can be axially positioned along the latter to adjust the distance between the anchoring flanges themselves depending on the geometrical features of the tyre 2 to be obtained.

The inflatable bladder 14 has a radial reinforcing structure 19 made up of textile or metallic cords disposed in radial planes with respect to a geometric rotation axis X-X and each extending between the opposite circumferential edges 14a of the inflatable bladder itself. Close to each circumferential edge 14a an annular anchoring structure 20 is formed that comprises annular inserts 20a, 20b each consisting of one or more textile or metallic cords wound up into radially superposed coils. In the example shown, integrated into each circumferential edge 14a of the inflatable bladder 14 there is a central annular insert 20a interposed between two series of cords belonging to the radial reinforcing structure 19 and overlapping each other in an alternate sequence on the axially inner side and the axially outer side respectively of the central insert itself. Also provided are two side inserts 20b, placed in an axially internal position and an axially external position respectively relative to the cords of the radial reinforcing structure 19.

Associated with the radial reinforcing structure 19 is a belting structure 21 comprising one or more textile or metallic cords circumferentially wound up into coils disposed in side by side relationship externally of the radial reinforcing structure 19, in a region delimited between two axially opposite edges 21a of the belting structure itself, suitably spaced apart from the circumferential edges 14a of the inflatable bladder 14.

In a preferential embodiment, the radial reinforcing structure 19 consists of metallic cords distributed according to a density included between 50 and 180 cords/dm and each comprising two to five filaments of steel with a diameter included between 0.06 mm and 0.2 mm. Each cord has a tensile strength included between 45 and 165 Newton, with an extendibility of 0.5% for a load included between ⅓ and ⅕ of the tensile strength.

Each annular reinforcing insert 20a, 20b can be in turn formed of a cord comprising 2 to 12 metal filaments of a diameter included between 0.2 mm and 0.45 mm. The tensile strength of the cord is preferably included between 550 and 1850 Newton, with an elongation corresponding to 0.5% for a load included between ⅙ and 1/7 of the tensile strength.

The belting structure 21 can consist of one or more cords comprising 2 to 5 metal filaments of a diameter included between 0.08 mm and 0.3 mm. The cord or cords may form coils disposed in accordance with a density of 50 to 135 cords/dm. Each cord preferably has a tensile strength included between 250 and 550 Newton, with elongation of 0.5% for a load included between 1/7 and ⅛ of the tensile strength.

The reinforcing inserts can be integrated, together with the ends of the cords forming the radial reinforcing structure, into high-modulus elastomer fillers of a hardness just as an indication in the order of 70° and 92° Shore A, arranged close to the end edges 14a of the inflatable bladder 14.

The inflatable bladder 14 is also provided to be coated, on its inner surface, with a layer of a highly impervious elastomer material 22, a butyl-based blend for example. The outer surface of the inflatable bladder 14 on the contrary is preferably coated with a layer of a non-sticking material 23, a silicone-based blend for example.

The anchoring flanges 16, 17 each comprise an axially external half-flange 24 and an axially internal half-flange 25 incorporating radially sliding members 26 engaging the corresponding circumferential edge 14a of the inflatable bladder 14 in such a manner that the circumferential edge itself is movable in a radial direction.

In more detail, the radially sliding members 26 contemplate arrangement of a plurality of blocks 27 circumferentially distributed close to the perimetric edge of at least one of the half-flanges 24, 25, in this embodiment the axially inner half-flange 25. Each block 27 is slidably guided in a radial direction along at least one guide column 28 extending through the block itself and rigidly engaged between a first annulus 29 and a second annulus 30 that are concentric and fastened to the axially inner half-flange 25, by screws 28a longitudinally passing through the guide columns 28 associated with the different blocks 27a, for example.

Each block 27 has a grip surface 31 acting in thrust relationship against the surface of the inflatable bladder 14 close to the inner circumferential edge 14a thereof, and an abutment lug 32 projecting in an axial direction to supply a further support seat for said inner circumferential edge.

The grip surface 31 is preferably provided with ribs extending substantially circonferentially to efficiently retain the inflatable bladder 14 and thus prevent radial slipping off of same with respect to block 27.

The circumferentially distributed blocks 27 act in thrust relationship against the circumferential edge 14a of the inflatable bladder 14, in contrast relationship with a radial abutment surface 33 formed in the axially external half-flange 24. In other words, each of the circumferential edges 14a of the inflatable bladder 14 is enclosed between the blocks 27 carried by the axially internal half-flange 25 and the radial abutment surface 33 formed on the axially external half-flange 24.

The first and second anchoring flanges 15, 16 are each provided to be associated with at least one circumferential seal 34 set to act against the inflatable bladder 14 to hermetically insulate the inner portion thereof from the surrounding atmosphere. This circumferential seal can be placed for example close to the second annulus 30, at a radially external position with respect to the first annulus 29, and possibly extending towards the geometric axis X-X, to act in sliding contact relationship against the inner surface of the inflatable bladder 14. The outer surface of the inflatable bladder 14 may be also provided to be slidably in sealing engagement against the radial abutment surface 33 formed on the axially external half-flange 24, after possible interposition of a second circumferential seal (not shown). The radial abutment surface 33 can be coated with a layer of antifriction material, Teflon® for example.

Elastic return members 35 consisting of Belleville washers fitted on columns 28 for example, constantly urge each block 27 towards the geometric axis X-X of the inflatable bladder 14.

Each anchoring flange 15, 16 may be also associated with an annular membrane 36 having a radially internal circumferential edge 36a and a radially external circumferential edge 36b sealingly fastened to the anchoring flange itself, at a radially external position and at a radially internal position respectively with respect to the radially sliding members 26. In particular, the radially internal edge 36a of the annular membrane 36 can be sealingly enclosed between the axially internal half-flange 25 and the first annulus 29, whereas the radially external edge 36b can be enclosed between the second annulus 30 and a third annulus 30a fastened to the second annulus 30. Said circumferential seal 34 can be formed on the end of the radially external edge 36b of the annular membrane 36.

Associated with each of the anchoring flanges 15, 16 is an annular abutment flange 37 to be positioned against an outer side surface of the inflatable bladder 14 to supply a support seat to the inner surface of tyre 2 close to a corresponding bead 5 of the latter. Each of these annular abutment flanges 37 is divided into a plurality of circumferential sectors 38, 39 each of them being movable between an operating position at which it has a substantially radial orientation with respect to the geometric axis X-X of the inflatable bladder 14 and a rest position at which it is radially retracted to enable disengagement of tyre 2 from the building support 9.

In more detail, first circumferential sectors 38 and second circumferential sectors 39 are provided which are consecutively distributed in an alternate sequence and respectively engaged with a first hub 40 and a second hub 40 axially movable with respect to each other and adapted to be positioned in side by side relationship with the respective anchoring flange 15, 16. The first hub 40 of each anchoring flange 15, 16 is preferably engaged by screwing on the first shaft 17 or on the second shaft 18 respectively, so that, when it comes in abutment against the respective anchoring flange 15, 16, it causes rotational locking of said flange with respect to the corresponding shaft 17, 18.

The second hub 41 can be axially moved close to the first hub 40 so that it lends itself to cause interposition of the second circumferential sectors 39 between the first circumferential sectors 38 carried by the first hub 40, in a surface continuity relationship therewith.

Torsion springs or other appropriate spring members operate between each circumferential sector 38, 39 and the corresponding hub 40, 41 to keep the circumferential sectors themselves to the operating position.

Also associated with the inflatable bladder 14 are inflating devices 42 to admit fluid under pressure thereto and bring said bladder to such an inflated condition that it acquires a substantially toroidal shape, with an outer surface conforming in shape to the inner conformation of the green tyre 2 to be built. These inflating devices may comprise an admission duct 43 for example for introduction of air or other fluid under pressure, which duct is longitudinally formed through the first shaft 17 and can be connected to a supply source arranged along the building line 12 to feed said pressurised gas. More particularly, the admission duct 43 of the first shaft 17 is preferably connected to said supply source during a starting step of the tyre working cycle, to set the inflatable bladder 14 to the inflated condition.

Preferably, during admission of the pressurised fluid to the inflatable bladder 14 a control of the geometric configuration of the bladder itself is carried out, so as to actuate stopping of fluid admission when bladder 14 has reached a predetermined size. In more detail, for the purpose, members (not shown in the drawings) for detecting the geometric configuration of the inflatable bladder may be provided, which members may comprise one or more photoemitters for example that operate at different points of the extension outline of bladder 14, each of them generating a light beam to be intercepted by the inflatable bladder itself on reaching of the inflated condition. Combined with the photoemitters are respective photoreceivers set to receive the respective light beams, directly coming from the photoemitters or reflected by the surface of the inflatable bladder 14, to operate stopping of fluid admission as soon as the photoemitter's light beam is intercepted by the outer surface of the inflatable bladder. It is to be noted that with use of laser beam photoemitters a very accurate control of the geometric configuration of the inflatable bladder 14 can be obtained, even with tolerances lower than 0.1 mm.

When the inflatable bladder 14 has reached its inflated condition, it is inflated to a pressure of a value, just as an indication, lower than 5 bars. Due to stiffness of the Belleville washers 35, blocks 27 can be kept in a radially retracted position when the bladder is in an inflated condition.

Once the inflated condition of the inflatable bladder 14 has been reached, the building support 9 is ready to receive the different components of tyre 2 to be made that are assembled on said support in the different work steps along the building line 12. Assembling of the tyre components can start with formation of the air-tight liner 4 through winding of a continuous strip of raw elastomers material into coils disposed consecutively in side by side relationship starting from one of the annular abutment flanges 37, in the region corresponding to one of the tyre beads, to cover the outer surface of the inflatable bladder 14 until reaching the annular abutment flange 37 placed on the opposite side of the bladder itself.

Formation of liner 4 is followed by assembling of all the other components 3, 5a, 6, 7, 8 of tyre 2 in a predetermined sequence, as described in document U.S. Pat. No. 6,318,432 in the name of the same Applicant, for example.

Advantageously, during assembling of the different components of tyre 2 along the building line 12, carrying out of a control of the inner pressure of the inflatable bladder 2 may be provided in a continuous manner or at predetermined intervals. In fact the Applicant has found that this inner pressure can be submitted to important variations following temperature rising or lowering taking place during working for example, which will adversely affect the geometric conformation of the inflatable bladder 14 being inflated. For the purpose devices 44 for control and maintenance of the inflating pressure in the inflatable bladder 14 are provided, which devices preferably comprise a pneumatic tank 45 (diagrammatically shown) associated with the first shaft 17 for example and connected to the admission duct 43 so that it can be loaded with pressurised fluid simultaneously with inflation of bladder 14. Combined with the pneumatic tank 45 are control members consisting of a manometric sensor 46 for example, connected with a shutoff valve 47 arranged on the tank itself to control admission of pressurised fluid to the inflatable bladder 14 if the inner bladder pressure goes below a predetermined value. The manometric sensor 46 may also control opening of an exhaust valve 48 associated with an outflow duct 49 of the pressurised gas from the inflatable bladder 14, to cause evacuation of the pressurised gas if the inner pressure in bladder 14 overcomes a predetermined threshold during building of tyre 2.

When tyre building has been completed, the building support 9 with the green tyre 2 formed thereon is transferred into the vulcanisation mould 13 wherein activation of over-inflating devices 50 is driven, upon the action of which an additional expansion of the inflatable bladder 14 is determined starting from the inflated condition. These over-inflating devices 50 can coincide with or be an integral part of the above described inflating devices 42 and may for example comprise an admission channel 51 and an evacuation channel 52 for a pressurised fluid, which are arranged lengthwise in the second shaft 18 and can be connected with a steam-feeding circuit or a circuit for feeding another vulcanisation fluid, usually associated with mould 13.

Therefore through the admission 51 and evacuation 52 channels, steam circulation to pressure values even exceeding 20 bars is allowed within the building support 9, said values being much higher than those required to bring and keep bladder 14 to the inflated condition in the preceding tyre building steps.

Therefore, the high pressure of the steam admitted to the inflatable bladder 14 causes over-inflation and further expansion of the bladder itself, so that compression of tyre 2 against the inner walls of mould 13 is ensured.

Due to the structure of the anchoring flanges 15, 16, the inner circumferential edges 14a of the inflatable bladder 14 are given some mobility in a radial direction. Consequently, the circumferential edges 14a of the inflatable bladder 14 are free to move in a radial and circumferential direction, dragging along blocks 27 with them, which blocks radially translate away from axis X-X and compress the Belleville washers 35 to help expansion of the bladder during over-inflation. Preferably, for reaching the over-inflated condition the inner circumferential edges are submitted to a circumferentially extending expansion at least of 2%.

When vulcanisation has been completed, ejection of the pressurised steam from the inside of the inflatable bladder 14 takes place through the evacuation channel 52 and, following pressure reduction, the Belleville washers 35 bring blocks 27 back to the first operating condition, causing separation of the inflatable bladder 14 from the inner surfaces of tyre 2.

The building support 9 with the finished tyre 2 thereon is extracted from mould 13 and they are subsequently separated from one another. For the purpose, the first and second shafts 17, 18 are mutually disengaged and, while tyre 2 is externally held by a handling device 53, a mutual approaching of the anchoring flanges 15, 16 can be carried out to cause separation of the tyre beads 5 from the circumferential abutment flanges 37. Subsequently axial moving apart of the second hubs 41 from the first hubs 40 is determined so that the second circumferential sectors 39 are free to take their rest orientation without mechanically interfering with the first circumferential sectors 38. During this axial-movement step the second circumferential sectors 39 carried by at least one of the second hubs 41, the hub associated with the first shaft 17 for example, are forced to move to the inside of the corresponding bead 5 of tyre 2, simultaneously with their dropping to the rest condition.

Subsequently, the anchoring flanges 15, 16 are operated so that they are axially separated from each other, causing the first circumferential sectors 38 of at least one of the first hubs 40, the hub associated with the first shaft 17 for example, to move to the inside of the tyre bead. Tyre 2, through the handling device 53, lends itself to be axially slipped off from one of the anchoring flanges 15, 16, the flange 15 associated with the first shaft 17 for example, as well as from the respective hubs 40, 41. A holding ring 54 may be advantageously fitted on the axially spaced apart hubs 40, 41 associated with the first shaft 17 to keep the circumferential sectors 38, 39 in the rest position.

The invention achieves important advantages, particularly in terms of improvement of the conditions adopted for carrying out moulding of tyre 2 and, consequently, of the quality of the finished product. Due to mobility of the inner circumferential edges 14a of bladder 14 in a radial direction, an excellent expansion of the bladder itself in the over-inflated condition is ensured as well as, as a result, an improved evenness in pressing tyre 2 against the walls of mould 13.

The construction features of the inflatable bladder 14 too, and in particular the extendibility of the circumferential edges 14a thereof in a circumferential direction, helps in obtaining the above advantages.

Due to mobility of the circumferential edges 14a, the stresses to which the inflatable bladder 14 on the whole is submitted during the over-inflating step are greatly reduced. Thus a longer duration of the inflatable bladder 14 is ensured and service interventions on the building support 9 are reduced.

It will be also recognised that the inflation control through control of the geometric configuration of bladder 14 offers an improved surveillance on the geometric uniformity of the obtained product. This improvement is also enhanced through control and maintenance of the inner pressure of the bladder at the end of the inflating operation, during execution of the whole process for building tyre 2.

Furthermore, the possibility of axially positioning the anchoring flanges 15, 16 along the respective first and second shafts 17, 18 enables the building support 9 to be adjusted for production of tyres of different sizes.

1-28. (canceled)

29. A method of manufacturing a tyre for a vehicle wheel, comprising:
inflating a bladder of a building support so that a shape of an outer surface of the bladder correlates with a shape of an inner surface of the tyre;
applying a plurality of elementary components onto the building support in order to build the tyre;
introducing the tyre and the building support into a vulcanization mould; and
curing the tyre;
wherein the bladder comprises circumferential edges coaxially spaced apart from each other, and
wherein during curing the tyre, the bladder is over-inflated so that the circumferential edges of the bladder are radially farther from a geometric axis of the bladder than when the bladder is not over-inflated.

30. The method of claim 29, wherein during transition between an inflated condition and an over-inflated condition, each circumferential edge of the bladder is slidably and sealingly guided in an anchoring flange associated with the building support.

31. The method of claim 29, wherein inflating the bladder comprises admitting a pressurized fluid into the bladder.

32. The method of claim 29, further comprising controlling a geometric configuration of the bladder.

33. The method of claim 31, wherein controlling the geometric configuration of the bladder comprises detecting interception of at least one light beam by the bladder when the bladder reaches an inflated condition.

34. The method of claim 29, wherein during applying the plurality of elementary components, at least an inflating pressure of the bladder is controlled.

35. The method of claim 29, wherein during over-inflating the bladder, the circumferential edges of the bladder are submitted to an elastic elongation in a circumferential direction of at least 2%.

36. The method of claim 29, further comprising:
deflating the bladder;
wherein deflating the bladder enables disengagement of the building support from the cured tyre.

37. The method of claim 29, further comprising:
disposing a pair of annular abutment flanges laterally close to the bladder;
wherein the flanges define support seats for respective beads of the tyre.

38. The method of claim 29, wherein over-inflating the bladder comprises introducing a vulcanization fluid at high pressure and temperature into the bladder.

39. An apparatus for building a tyre for a vehicle wheel, comprising:
a building support; and
inflating devices;
wherein the building support comprises:
a bladder; and
axially opposite anchoring flanges;
wherein the bladder comprises circumferential edges coaxially spaced apart from each other,
wherein the anchoring flanges engage the circumferential edges of the bladder,
wherein radially sliding members associated with the anchoring flanges allow radial movement of the circumferential edges of the bladder,
wherein the inflating devices are associated with the bladder,
wherein the inflating devices allow inflation of the bladder so that a shape of an outer surface of the bladder correlates with a shape of an inner surface of the tyre, and
wherein the tyre is built with a plurality of elementary components.

40. The apparatus of claim 39, further comprising:
over-inflating devices;
wherein the over-inflating devices cause additional radial expansion of the bladder from an inflated condition.

41. The apparatus of claim 39, wherein the radially sliding members comprise, for each anchoring flange:
a plurality of blocks;
wherein the blocks are circumferentially distributed and slidably guided in a substantially radial direction on the anchoring flange, and
wherein the blocks rigidly engage a corresponding circumferential edge of the bladder.

42. The apparatus of claim 41, wherein each circumferential edge of the bladder is enclosed between respective blocks and a radial abutment surface defined in a respective anchoring flange.

43. The apparatus of claim 42, wherein the bladder is slidably and sealingly engaged against the radial abutment surfaces.

44. The apparatus of claim 41, further comprising:
elastic return members;
wherein the elastic return members urge the blocks toward a geometric axis of the bladder.

45. The apparatus of claim 39, wherein at least one circumferential seal is associated with each anchoring flange, and
wherein the at least one circumferential seal acts against the bladder in a radially external position relative to the radially sliding members.

46. The apparatus of claim 39, wherein at least one annular membrane is associated with each anchoring flange,
wherein the at least one annular membrane comprises:
a radially internal circumferential edge; and
a radially external circumferential edge;
wherein the radially internal circumferential edge is sealingly fastened to the anchoring flange at a radially internal position relative to the radially sliding members, and
wherein the radially external circumferential edge is sealingly fastened to the anchoring flange at a radially external position relative to the radially sliding members.

47. The apparatus of claim 39, wherein the anchoring flanges are fastened to a first shaft and a second shaft respectively, and
wherein the first and second shafts are telescopically slidable into one another.

48. The apparatus of claim 47, wherein the inflating devices comprise:
at least one pneumatic admission duct formed in at least one of the first and second shafts.

49. The apparatus of claim 39, further comprising:
devices for control and maintenance of inflation pressure of the bladder during assembling of the components of the tyre on the building support.

50. The apparatus of claim 49, wherein the devices for control and maintenance of inflation pressure comprise:
a pneumatic tank; and
control members;
wherein the pneumatic tank is associated with the building support, and
wherein the control members are interconnected with the pneumatic tank to keep the inflation pressure of the bladder controlled in an inflated condition.

51. The apparatus of claim 39, wherein the circumferential edges of the bladder exhibit, in an over-inflated condition, an elastic circumferential elongation of at least 2%.

52. The apparatus of claim 39, further comprising:
two annular flanges;
wherein the annular flanges are disposed at opposite positions respectively, against outer side surfaces of the bladder, and
wherein each annular flange defines a rigid abutment surface for formation of a bead of the tyre being built.

53. The apparatus of claim 52, wherein each annular flange comprises circumferential sectors movable between:
an operating position; and
a rest position;
wherein in the operating position, the circumferential sectors have a substantially radial orientation relative to a geometric axis of the bladder, and
wherein in the rest position, the circumferential sectors are radially retracted to enable disengagement of the tyre from the building support.

54. The apparatus of claim 53, wherein each annular flange comprises:
first sectors; and
second sectors;
wherein the first and second sectors are circumferentially distributed in an alternating sequence,
wherein the first sectors engage a first hub,
wherein the second sectors engage a second hub, and
wherein the first and second hubs are axially movable with respect to one another.

55. The apparatus of claim 39, further comprising:
detecting members;
wherein the detecting members are associated with the inflating devices,
wherein the detecting members detect a geometric configuration of the bladder, and
wherein the detecting members stop admission of pressurized fluid into the bladder when the bladder has reached predetermined size.

56. The apparatus of claim 55, wherein the detecting members comprise:
at least one photoemitter; and
a photoreceiver;
wherein the at least one photoemitter generates a light beam to be intercepted by the bladder in an inflated condition, and
wherein the photoreceiver receive the light beam if the light beam is not intercepted.

57. A plant for manufacturing a tyre for a vehicle wheel, comprising:
a building apparatus;
inflating devices;
devices for applying a plurality of elementary components of the tyre onto a building support;
at least one mould for curing the tyre; and
devices for transferring the building support into the at least one mould;
wherein the building apparatus comprises the building support,
wherein the building support comprises a bladder,
wherein the bladder comprises circumferential edges coaxially spaced apart from each other,
wherein the inflating devices are associated with the bladder,
wherein the inflating devices allow inflation of the bladder so that a shape of an outer surface of the bladder correlates with a shape of an inner surface of the tyre, and wherein the circumferential edges of the bladder are radially movable in order to allow additional radial expansion of the bladder from an inflated condition.
